(19) United States
(12) Patent Application Publication
(10) Pub. No.: US 2016/0377046 A1
(43) Pub. Date: Dec. 29, 2016

(54) IMPROVED FACILITY FOR CAPTURING SEA ENERGY

(71) Applicant: Ivan DIB ECHEVERRIA, Santiago (CL)

(72) Inventor: Ivan DIB ECHEVERRIA, Santiago (CL)

(21) Appl. No.: 15/103,700

(22) PCT Filed: Dec. 9, 2014
(86) PCT No.: PCT/CL2014/000070

§ 371 Date: Sep. 15, 2016

(30) Foreign Application Priority Data
Dec. 11, 2013 (CL) 3557-2013

(51) Int. Cl. F03B 13/16

(52) U.S. Cl. CPC F03B 13/16

(57) ABSTRACT

The invention provides improvements to the facility described in patent applications WO 2011/123966 and CL 0260-2013 by means of an improved facility for capturing sea energy, which increases the stability of the system and stimulates the relative movement for generating energy, and comprises a main structure and a driving tank (11), where said main structure is formed by two perpendicular supporting beams having a first beam section (2) and a second beam section (3) which form an angle between each other in the vertical plane.

### SPECIFICATION

The present invention relates to an improved equipment to capture sea energy. For this, the present invention provides improvements to the equipment described in patent applications WO 2011/123966 and CL 0260-2013, where these improvements focus on modifying the structure described in the aforementioned patent applications in order to improve the performance thereof, based on its architecture and operation.

### BACKGROUND OF THE INVENTION

Various appliances and devices to capture energy from ocean waves are disclosed in the prior art, with a great variety of designs, sizes, types of anchoring and operating principles having been found therein, as specified in the examples mentioned in the patent application CL 0260-2013.

Other examples of floating equipment for capturing energy from waves are for instance disclosed in documents ES 2415239, U.S. 2010043425, U.S. 2013140821, U.S. 2013234440, WO 2011065841, WO 2013068748, etc.

Whatever the mechanism to generate electricity (hydraulic cylinders, pneumatic cylinders, propellers, folding doors), this has to be supported by a structural assembly to support said mechanism, and said assembly must in turn have a mechanism or equipment to approach to the water motion.

Currently, most of the water-approaching equipment are fixed to the coastline or fixed to the sea bottom. In the case of those fixed to the coastline, the main difficulty corresponds to the variation in the height of water during the 24 hours-day, where the equipment rises and falls with the tide and where also, occasionally, it rises during swells or becomes even subject to tsunamis.

Generally, these pieces of equipment must be provided with clockwork mechanisms or electronic control systems, or simply being out of water's reach, therefore becoming inoperative during part of the day. If to these complications we add the fact that the waves reach the coastline when they are losing their last portion of its remaining power and the single thrust vector remaining is the horizontal vector, then it is understandable why these machines are only built as prototypes and never built on industrial scale. When the equipment is fixed to the seabed, the performance usually improves, but technical difficulties are even higher. Indeed, in fastening the equipment to the seabed, the structure supporting it suffers all the effects of impacts and disturbances generated by the changing tides, because by being inside the water the equipment is subject to abuse and often to total destruction.

It is important to understand that any equipment or mechanism submerged with people aboard must have proper protection and precautions to ensure safety of human life. Generally this raises the overall manufacturing costs to such levels that they can be manufactured only with subsidies, or with scientific purposes, but in no case on industrial scales with business results. To the problems above, all environmental impacts must be added, especially the visual ones, created by the equipment that occupy the coastline, because due to tourism, sport, productive reasons or some other type of reasons, any development of this kind invades areas of high alternative value, with all consequences resulting from this situation.

Countries like Chile, where the best coastline waves can be found, are those countries with the steepest depth gradient and this forces the equipment attached to the seabed to be very close to the shore or raise their costs of installation to such high levels that they cannot compete to generate electricity.

Thus, if we want to ensure the functioning of equipment for 40, 50 or more years facing swells, storms, tides, tsunamis, without the opposition of residents and fishermen of the coastline, the only solution is to design equipment able to float in the sea and to do so without major restrictions of depth, away from the coastline breakers.

For a body to be designed where waves go in and out as freely as possible, it must be built with floating piles, or as floating walls.

The presence of closed hulls, which are characteristic of shipbuilding, severely limits the undivago motion and it is therefore not recommended.

Building with piles or floating walls can be vertical or angled, depending on the characteristics of the equipment, but it is clear that by angling the piles, the thrust forces of the water break down according to their direction, making it possible to sustain a central tower in the ocean. All this technology has been applied in time, especially in the construction of oil drilling towers and equipment for coastal towers offshore.

For work or energy to be produced, relative motion between two bodies must be ensured. It is very easy to capture the relative motion on and or fixed to the seabed, because the ground or the bottom are fixed and the placement of a sphere, a float or a paddle is enough to get the motion, which becomes relative with respect to an axis, a pivot, an eyebolt or anything fastened to the land. It is therefore possible to achieve relative motion and energy, but as mentioned above, these devices do not work at sea and eventually they end up destroyed or its maintenance costs become so high that they are not profitable.

The problem then arises as to how to obtain relative motion in the middle of the ocean without any foothold, i.e., solely by flotation which so far is possible under the four ways described below:

a) Separating the Point of Buoyant from the Point of Generation

It is known that the swell is undulatory and therefore its spread in water is through waves that never have the same height.

Now, if floating or buoyant points are installed at a certain distance of the equipment that raises and lowers to generate power, then the height of the centers of buoyancy will never match the height of the drive unit and therefore the relative motion will produce. For example, if you have a 2-meters wave high and with a length of around 100 m, which is typical of the central coast of Chile, and if we assume that the waveform is very similar to an isosceles triangle with a height of 2 m, then we can conclude that for every 10 m of distance, the increase or decrease in height will be approximately 0.4 m. Now, if the fulcrum of buoys is installed at 10 m of the drive equipment, there will be always a gap of 40 cm or 0.4 m, which under constant oscillation corresponds to a permanent relative motion.

### b) Through Mass Difference

If two bodies of completely different masses are left floating on the water, such as an iceberg and an inflatable boat, and both bodies are in standing water, then we would have a situation of equilibrium for both. However, on one hand we have a huge mass of tones, while the other light body weighs a few kg out of water.

For now, both of them float alike; furthermore, assuming that the portion of them that sticks out of the water has the same volume in both cases, when a typical wave enters at a rate of 4-8 m/s, fully flooding the volumes sticking out of water, both bodies will receive an absolutely equal rising thrust or buoyancy.

For some seconds, the initial balance will be completely convulsed, producing a transient in which both bodies will seek the balance they had, rising in height, but the inflatable boat will come up like a cork, while the iceberg will remain almost static.

Part of the explanation of this phenomenon is based on the enormous mass of the iceberg, which in contact with water provides resistance throughout its extension as a result of friction.

Moreover, from the marginal buoyant point both bodies received when the wave came in, the marginal weight that also entered the bodies should be subtracted. In the case of the iceberg this marginal weight is proportionally much higher, which added to the effect of friction allows the boat to rise faster than the iceberg, which hardly moves.

Therefore, if the construction of a generating body is possible, where a large mass heavy structure coexists with a significantly lighter (of smaller mass) drive tank, then any wave approaching to both bodies will relatively move one body more than the other, resulting in the relative motion desired, provided that the marginal buoyant potential of both of them is equal to or less for the structural mass, since the lifting force to be received by the structure will be less than or equal to the drive reservoir.

### c) Through Potential Buoyant Difference

The third cause of relative motion is the difference of the potential buoyant point. The entire volume of reservoirs, floats, or structures exceeding the flotation level in a floating body constitutes the potential buoyant as it is there but not used or it does not appear until a marginal volume of water caused by a wave covers it completely or partially. Let us keep in mind that the Archimedes principle is a reactive force. Let us assume that we have two bodies of equal mass floating in the sea under balance, with one of them corresponding to one long small diameter cylinder, such as a water pipe capped at both ends and with a greater weight in one end to maintain verticality, and the other one corresponding to a body like a wide low altitude flying saucer; both bodies have the same weight on land and, hence, the same mass; additionally both of them freely float in the water under balance, and both have the same volume of inner back-up air without flooding, but one of them has this volume in a flat body spread over the water and the other one in a long body away from the water level.

When a wave floods the periphery of both bodies, the flat and long body will be completely covered, while the other one will be flooded in only a fraction of its long body. The instant result of this is that both bodies will tend to rise with the wave seeking their equilibrium waterline, but the force of upwards thrust will be totally different because the flooded volumes are totally different from the time the water floods them. This marginal flood is the acceleration source that will rise in proportion to the flooded volume. Therefore, in the first case this acceleration will be much greater and the additional source of thrust in the flat long body will cause in the flat long body a greater acceleration moving it away from the long body, and thus obtaining the relative motion.

d) By Neutralizing the Buoyant Point with a Variable Hanging Mass

The three sources of relative motion discussed above may be more or less efficient as far as engineering and science of materials allow maximizing the distance between the center of the buoyant point and the generation center, as well as maximizing the mass differences between the supporting body and the generation point without sacrificing manufacturing costs to a large extent. Finally, the geometric shape of facing the wave with the marginal buoyant point could also make their contribution to the extent the volumes do not increase costs significantly. But still, we must not forget that we must take the most of the wave and the three prior elements may not be enough for a highly productive generation.

Neutralization of the buoyant point aims at maintaining the supporting structure stable by simple mechanisms acting for natural causes.

One of such mechanism involves hanging weights from the equipment, which while being in standby mode keeps such weights at the bottom of the sea and do not alter the floatation of the equipment. However, when a wave comes in and the pressure to lift the assembly starts, these weights rise, thus partially neutralizing lifting.

Therefore, the objective of the present invention is to provide an improved equipment to capture energy from the ocean waves that may meet the principles described above, thereby achieving a stable support structure with a better relative motion between the main structure and the driving elements, thus making better use of the wave motion and therefore a greater capture of energy thereof for the generation of electricity later on.

### SUMMARY OF THE INVENTION

The present invention consists in providing an improved structure to the equipment to capture energy as defined in the patent application CL 0260-2013, where now a floating structure is proposed that does not require support and that can be installed offshore. The improved equipment for capturing energy from waves, which is the object of the present invention, is made up by a base consisting of two perpendicular supporting beams lifting upwards at a certain angle and joining at the center of the structure via a central mass. From this central mass, a central column lifts perpendicularly to the horizontal line; said column is connected at its upper end with a control platform where the equipment of electric power generation and the equipment's operation area are arranged. In addition, from this platform four supporting beams arise which connect to the upper end of each supporting beam, so that to provide stability to the equipment when it is floating.

The inclination of the supporting beams allows a vector to form at its upper end aiming to the center of the structure, which is represented by the stabilizing beams attached to the central column so that any force produced by the waves and attempting to destabilize the structure will be compensated and transmitted by the vector, i.e., by the stabilizing beams towards the central column, always keeping the structure in equilibrium regardless of the magnitude of said force.

On the upper inclined portion of each supporting beam there is a float, preferably of cylindrical and elongated shape, which is responsible for keeping the structure afloat maintaining a certain waterline when the equipment is on standby mode and passes near the upper ends of floats.

In the center column of the equipment there is a drive reservoir, preferably flat and long, which moves freely along the column as the result of the wave motion. Said drive reservoir is connected by the inside of the central column to a generating reservoir located within a hydraulic cylinder arranged on the control platform, so that the drive reservoir transfers the energy produced by the motion of waves to said generating reservoir which is finally transformed into electrical energy by the generator set.

In another aspect of the invention, at the bottom of each supporting beam there is a chain connected having neutralization mass of the buoyant point on its ends. These neutralization masses are supported on the seabed when the equipment is on standby mode and rise when said equipment moves with the waves. It should be noted that the length of the chain holding the weights, as well as the number and size thereof, depends on the geographical conditions of the seabed and on the wave conditions of that portion of the ocean where the equipment is arranged. So in areas where waves are more intense a longer chain and more weights shall be necessary to stabilize the equipment and to withstand even such strong waves as those produced by a tsunami. Likewise, the equipment is engaged below the central mass to an anchor chain attached to an anchor in order to fasten the device to the seabed, where the length of the chain will also depend on the conditions of the area where it is installed in order to provide the equipment with more or less freedom of motion according to the wave conditions in the area. Optionally, a damping element can be arranged in the anchoring chain to reduce the impact of the strong waves on the equipment.

The configuration of the present invention gathers the four principles formulated to obtain the relative motion by flotation.

First, the inclination of the supporting beams allows obtaining proper separation between the buoyant point and the point of generation; this corresponds to the distance between the central column and buoyant centers located approximately ¼ from the top end of floats.

Second, there is a big difference between the mass of the drive reservoir and that of the structure of the equipment, mainly configured by the supporting beams, floats, stabilization beams, control platform and the center column. When the wave goes through the equipment to capture energy, this difference allows that the heavier mass, in this case the structure, remains relatively stable while the drive reservoir with a much smaller mass may move almost in unison with the frequency of the wave being able to capture all the energy from its motion.

Third, the flat and long design of the drive reservoir in relation to the length of the equipment structure and to the distance it can travel in the center column, allows forming a significant difference in the buoyant point; this makes it possible a greater relative motion and, therefore, to capture energy even when the motion of the waves is less.

Fourth and finally, the neutralization system made up by the system of chains and masses allows the efficient neutralization of the motion of waves, whatever its magnitude; this allows a smaller motion of the structure when said waves go through it, so that the drive reservoir may have a greater range of relative motion and thus higher rates of energy capture.

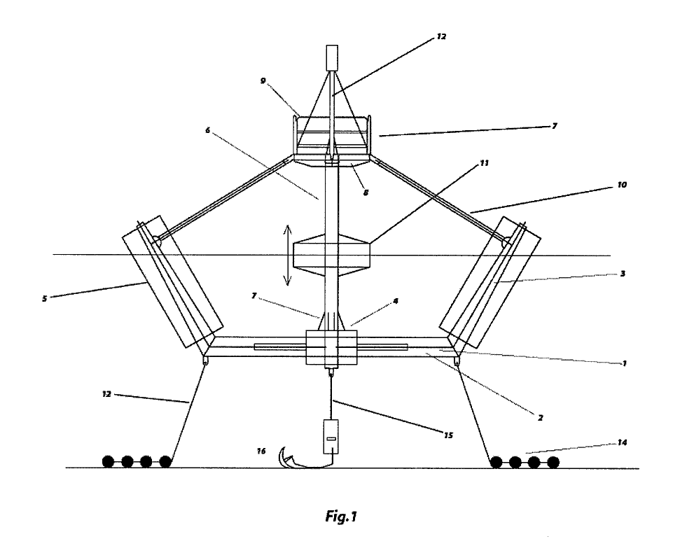

The principles gathered by the present invention in order to facilitate the relative motion between the structure and the drive reservoir therefore enable greater power generation while increasing the stability of the equipment when it is afloat; this is solely due to its design as shown in FIG. 1, which has been provided for a better understanding of the invention and schematically represents the characteristics of the invention in a front view.

### DETAILED DESCRIPTION OF THE INVENTION

According to FIG. 1, there is an improved equipment for sea energy capture comprising supporting beams (1) formed for example of two tight, metal double H-beams located perpendicularly each other and comprising a first section of beam (2) parallel to the horizontal which are joined in the center from a central mass (4) formed of a metal cylinder.

At a remote portion from the central mass, the supporting beams (1) comprise a second section of beam (3) which is inclined and forms an angle to the vertical axis, wherein the width of said second section of beam (3) is preferably less than the width of the first section of beam (2) and gradually decreases toward its upper end.

The equipment comprises four floats (5) formed by a cylindrical structure, which are arranged in each second section of the beam (3) and whose dimensions may vary depending on the size of the equipment to capture energy, which will be determined based on the sea conditions where it is installed or the skills required to generate energy.

Floats (5) are preferably made of metal material and have air inside to provide the necessary buoyancy to the equipment and it can also be filled with special materials to prevent water from entering in case of any contingency.

From the lower central zone of the equipment, there is at least a central column (6) on the central mass (4), having lower supports of the column (7) on its lower end consisting in metal plates welded to the column and connected to the central mass (4) for attachment.

The central column (6) rises above the supporting beams (1), beyond the second sections of the beam (2), wherein at its upper end it connects to a control platform (7) formed by a platform base (8) preferably of rectangular shape and rails (9).

This control platform (7) provides a suitable surface for the control of the equipment by an operator and for the arrangement of electrical energy generation equipment (not shown) such as those described in patents WO 2011/123966 and CL 0260-2013.

The control platform (7) is connected to the supporting beams (1) through the stabilizing beams (10) consisting of metal bars joined at their ends to the platform base (8) and to the second section of the beam by pivotal attachments where the attachment of the supporting beams (10) with respect to the second section of the beam (3) is preferably made at the upper end or near it. This position may vary according to needs and equipment size. Furthermore, in a preferred embodiment of the invention, on one of the four stabilizing beams (10) it is possible to have a ladder with rails (not shown) to allow a user from a vessel to board the equipment for maintenance or control.

In the central column (6) between the lower supports of column (7) and the platform base (8) there is a drive reservoir (11) consisting of a hollow cylindrical, flat edge structure, which size will depend on the environmental conditions of the place where the equipment is installed and maintaining a distance to the floats (5) located in the second sections of beam (3).

The construction of the drive reservoir (11) allows its free motion along the central column (6) driven by the wave motion. In addition, the drive reservoir (11) is connected to an upper reservoir (not shown) arranged within a hydraulic generating cylinder (12) by a line passing through the inside of the central column (6). Said hydraulic generating cylinder (12) is located on the control platform (7) concentrically to the central column (6) through which the drive reservoir (11) moves. Said upper tank and generating hydraulic cylinder (12) have a function as that described in patent CL 0260-2013 for transmitting the motion of the drive reservoir (11) produced by the waves to the generating equipment located on the control platform (7).

The equipment for energy capture has on the underside of the ends of the first beam section (2) an anchor for a buoyant neutralization system (13) hanging from the equipment and consisting of a line formed by a cable, chain or any anchorage element, having neutralization masses (14) on its ends. These masses can be for example metal balls, which are arranged by a separation in the line.

When the equipment is on the standby mode as shown in the figure, all neutralization masses (14) lay on the seabed; however, when the equipment tends to leave standby mode as a result of waves passing, the masses progressively rise keeping it in a stable position, so that the relative motion of the drive reservoir (11) is produced.

The number of neutralization masses (14) to be arranged in a line, as well as its separation, depend on the conditions of the area where the equipment is installed; therefore, in areas with intense swells and great size waves, a greater number of neutralization masses (14) will be necessary or a greater separation between them so as to give a wider range of motion without the masses being suspended in the water after the passing of strong swells or increase in tides.

Similarly, the equipment is fastened to the seabed where it is located by means of an anchor chain (15) connected to an anchor (16) where it is possible to provide a damper (17) therebetween in order to minimize the impact of the motion of the equipment produced by the waves on the anchor (16).

1. An improved equipment to capture sea energy that increases the system stability and enhances the relative motion for power generation, comprising a main structure and a drive reservoir (11), CHARACTERIZED because said main structure is formed by two perpendicular supporting beams (1) having a first beam section (2) and a second beam section (3) that form an angle therebetween in the vertical plane.

2. An improved equipment to capture sea energy according to claim 1, CHARACTERIZED because said supporting beams (1) are connected at the center with a central mass (4) in which a central column (6) is supported with a control platform (7) at its upper end connected by stabilizing beams (10) to each second beam section (3).

3. An improved equipment to capture sea energy according to claim 1, CHARACTERIZED because said first beam section (2) is parallel to the horizontal and the width of the second beam section (3) is preferably less than the width of the first beam section (2) and gradually decreases toward its upper end.

4. An improved equipment to capture sea energy according to claim 3, CHARACTERIZED because the supporting beams (1) are formed by tight, metal double H-beams.

5. An improved equipment to capture sea energy according to claim 2, CHARACTERIZED because said central column (6) is formed by at least one straight profile column and comprises at its lower end lower column supports (7) consisting of metal plates welded to the central column (6) and the main mass (4).

6. An improved equipment to capture sea energy according to claim 5, CHARACTERIZED because the central column (6) rises above the supporting beams (1), beyond the second beam sections (2).

7. An improved equipment to capture sea energy according to claim 2, CHARACTERIZED because the control platform (7) consists of a rectangular base platform (8) and metal rails (9).

8. An improved equipment to capture sea energy according to claim 7, CHARACTERIZED because there are pieces of equipment to generate electric power on the control platform.

9. An improved equipment to capture sea energy according to claim 2, CHARACTERIZED because the stabilizing beams (10) consist of metal bars and are connected to the platform base (8) and to the second beam section by pivotal attachments at their ends.

10. An improved equipment to capture sea energy according to claim 9, CHARACTERIZED because the stabilizing beams (10) are joined at the upper ends of each second beam section (3).

11. An improved equipment to capture sea energy according to claim 9, CHARACTERIZED because in one of the stabilizing beams (10) there is a ladder with rails.

12. An improved equipment to capture sea energy according to claim 2, CHARACTERIZED because the driving reservoir (11) is provided in the central column (6) and is formed by a hollow, flat edges cylindrical structure.

13. An improved equipment to capture sea energy according to claim 12, CHARACTERIZED because the driving reservoir (11) is connected to an upper reservoir arranged inside a hydraulic generating cylinder (12) through a line passing by the inside of the central column (6), with said hydraulic generating cylinder (12) being located on the control platform (7) concentrically to the central column (6).

14. An improved equipment to capture sea energy according to claim 1, CHARACTERIZED because it comprises floaters (5) arranged in each second beam section (3).

15. An improved equipment to capture sea energy according to claim 14, CHARACTERIZED because said floats (5) are comprised of a cylindrical structure of metallic material and filled with special materials to prevent water from entering.

16. An improved equipment to capture sea energy according to claim 1, CHARACTERIZED because it has an anchor for a buoyant neutralization system (13) hanging from the equipment and consisting of two or more lines with neutralization masses (14) at their ends.

17. An improved equipment to capture sea energy according to claim 16, CHARACTERIZED because the line of the buoyant neutralization system (13) is a cable, chain or similar fastening element.

18. An improved equipment to capture sea energy according to claim 16, CHARACTERIZED because the neutralization masses are metallic spheres.

19. An improved equipment to capture sea energy according to claim 1, CHARACTERIZED because it has an anchor chain (15) connected to an anchor (16) where a damper (17) is arranged therebetween.
